(19) United States
(12) Patent Application Publication
(10) Pub. No.: US 2011/0290080 A1
(43) Pub. Date: Dec. 1, 2011

(54) Nail Clipper With Nail Polish Bottle Top Twist Off Capabilities

(76) Inventors: Dennis William McDuffee, Gardenerville, NV (US); Gloria Loraine Kenyon, Gardnerville, NV (US)

(21) Appl. No.: 12/790,923

(22) Filed: May 31, 2010

(51) Int. Cl. B67B 7/44; A45D 29/00; B67B 7/18

(52) U.S. Cl. 81/3.09; 81/3.4; 30/28

(57) ABSTRACT

Tools, such as nail clippers, include at least one lever pivotally movable towards and away from another portion of the tools. Yieldable gripping pads of elastomeric material such as rubber, yieldable plastic or the like are disposed on facing surfaces of the lever. The facing pads are usable for clamping about the screw on top of a bottle of nail polish inserted between the pads allowing twisting off of the top by counter-clockwise rotation of the tool relative to the nail polish bottle.

### BACKGROUND OF THE INVENTION

1. Field of the Invention

This invention relates generally to a tool for twisting off the screw caps of containers, such as nail polish bottles, and more particularly to a nail care implement such as a nail clipper which includes a tool for twisting off the screw top on a bottle of nail polish.

2. Description of Related Art

Screw cap removers as well as nail clippers are known in the prior art. More specifically by way of example, U.S. Pat. No. 4,509,784 to Vollers discloses a split ring having a cap gripping inner surface about a central aperture adapted to receive a bottle cap, and a pair of handles attached to said ring and extending in generally the same direction away from said ring, said handles being manually graspable and movable relatively toward one another to draw said ring surface into forcible gripping engagement with the cap, whereby the handles may then be rotated to rotate and loosen the cap.

U.S. Pat. No. 2,641,943 to Krize, Jr. discloses a bottle screw cap remover which may be employed with a wide range of different sizes of bottle screw caps.

The device may be employed to remove a wide range of different sizes of screw caps, since the conical configuration of the recess allows the device to be placed over any screw cap which may be received in recess. It is shaped in the form of a human figure having a flat bottom with conical recess opening having straight saw blades secured in its wall forming the gripping elements when the body is placed over a cap to be removed.

U.S. Pat. No. 3,583,263 to Herigstad relates to a cap remover particularly effective for removing screw-threaded caps from containers such as beer and soda pop bottles. The screw cap remover has a plastic body with a disc-shaped handle element and an opening for receiving a cup-shaped rubber gripping element. The sides of the cup-shaped rubber element are secured to the body. A spring is positioned between the body and the top wall of the gripping element to form a dimple to eject the cap after it is removed from a bottle.

U.S. Pat. No. 7,367,248 to Ruffner discloses a screw top opener with two handles which can be pivoted. A first clamping jaw is formed on the first handle and a second clamping jaw is formed on the second handle. A screw top can be grasped by the two clamping jaws. A distance between the clamping jaws can be reduced by pivoting the two handles against each other. In accordance with this invention, a first clamping jaw is embodied on a straightedge, which can be pushed into the first handle and can be arrested in a multitude of positions with respect to the first handle. Thus, it is possible to achieve a short linear extension of the screw top opener without foregoing the comfort of being able to also grasp and open large screw tops.

U.S. Pat. No. 3,760,657 to Muir, et al, discloses a cap removing device consisting of a base member made of thermo-plastic material, and having a teat-drop shape opening, with one side having in part, a convex curve, and the other side having a concave curve. A metallic strip member is embedded in the thermo-plastic material along-side the convex side with one edge of the metallic strip member exposed and extending into the opening, there being saw-toothed formations along the exposed edge.

U.S. Pat. No. 4,341,015 to Young discloses a clipper assembly for clipping nails, including a nail clipper with a flexible housing attached to the nail clipper for collecting nail clippings during and after operation.

U.S. Pat. No. 4,017,923 to Schantz discloses a finger nail retainer and tweezer for use with a conventional nail clipper. The retainer and tweezer is used with a conventional nail clipper having a pair of elongated cutting blades fastened together at a rear end and having cutting blades at a forward end. The retainer and tweezer is made of spring steel and is of a generally V-shaped construction fitting over the pair of cutting blades and covering the space therebetween to retain nail clippings. The retainer and tweezer when removed from the nail clipper can be squeezed together and serve a particularly advantageous function as a tweezer

### SUMMARY OF THE INVENTION

In an exemplary embodiment of the present invention, there is disclosed a hand tool including means for performing a clipping function and a nail polish bottle cap twist off function comprising:

a first member in the form of an elongated lever pivotally mounted for movements, by hand of a user, towards and away from a second member having a cutting edge for performing a finger nail of toe nail clipping function; and

yieldable gripping material on surfaces facing toward one another of said first and second members for twist off clamping engagement with the cap of a nail polish bottle disposed between said pads.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings n which similar elements are given similar reference numerals.

FIG. 1 is a side elevation of a nail clipper in its operating position in accordance with the principles of the invention;

FIG. 2 is a perspective view of a conventional nail polish bottle;

FIG. 3 is a perspective view of another conventional nail polish bottle;

FIG. 4 is a perspective view of the nail clipper in its operation position in accordance with the principles of the invention; and

FIG. 5 is a side view of another embodiment of the invention.

### DESCRIPTION OF THE PREFERRED EMBODIMENT

Twisting off caps from containers can be quite difficult. This is particularly the case with small containers such as nail polish bottles where the bottle cap is generally of such small size as to make it difficult to grasp. Also, the nail polish within the bottle can harden on the screw threads tending to cement the cap to the bottle.

Tools for forcibly twisting off bottle caps are known, of course, but an object of the present invention is to avoid the need for a separate tool by adding a nail polish bottle cap twist off capability to known nail clippers. The tool includes one or more elongated levers pivoted for rotation about a fulcrum towards and away from another portion of the tool. In accordance with this invention, modifications of the lever portions of the tool are made by adding a cap twist off capability to the tool.

There is disclosed a multifunctional tool which serves as a nail clipper, and screw cap twist off remover for small bottles such as nail polish containers. The tool includes one or more elongated levers pivoted for rotation about a fulcrum towards and away from another portion of the tool.

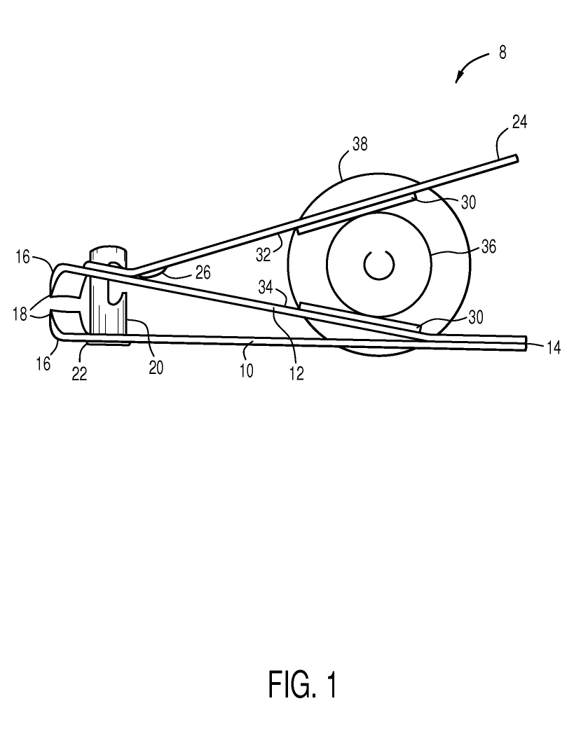

Referring to FIG. 1, there is shown a side elevation of a nail clipper 8 in accordance with this invention. The clipper 8 includes first and second overlapped and coextensive elongated metal members 10 and 12 joined at first ends 14 of the members and shaped to diverge towards spaced apart second ends 16 thereof. The second ends 16 are bent towards one another and include facing cutting edges 18. A pin 20, held in place by means of an enlarged collar 22, extends between the two members slightly rearward of the cutting edge 18. The pin 20 extends through and beyond the second member 12 and is engaged by a lever 24 including an enlarged portion 26 forming a fulcrum about which the lever 24 can be pivoted.

Movement of the free end of the lever 24 towards member 12 causes rotation of the fulcrum 26 against the second metal member 12 which drives the second end 16 of the member 12 towards the first member 10 to close the cutting edges 18 of the two members against one another.

To the extent described, nail clipper 8 is of known type and has no capability for twisting the top off a bottle of nail polish. Such capability is now provided according to the present invention, by the addition of a yieldable gripping material such as pads or sleeves 30 of an elastomeric material such as, for example, rubber, a yieldable plastic, etc. which can have a surface that is rough or smooth and, in another embodiment where a pad or sleeve 30 is located on one facing surfaces 32 (on the lever 24) and serrations or transverse ridges are located on facing surface 34 (on the metal strip 12). Accordingly, by inserting a cap 36 of a nail polish bottle 38 in the space between the two pads 30, and pressing lever 24 and second metal member 12 against the cap, the cap 36 on the bottle of nail polish is firmly clamped between the rubber pads 30 on the lever 24 and on the member 12 of the nail clipper. With the nail clipper tool now clamped about the bottle cap, counter-clockwise rotation of the entire tool relative to the bottle while holding the lever 24 and second metal member 12 clamped against the cap 36 applies a twist off force to the cap.

Referring to FIG. 1, a hollow cylinder of yieldable gripping material can be telescoped onto one or both of lever 24 and the overlapped metal members 10 and 12.

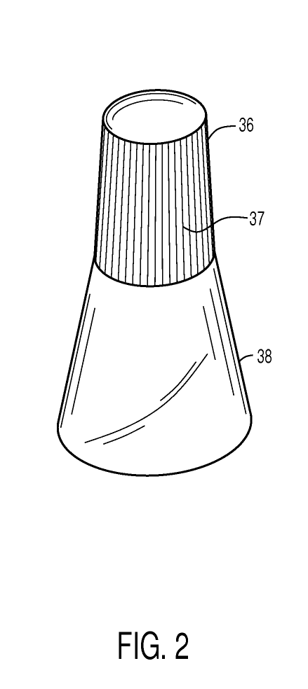

Referring to FIG. 2, there is shown a perspective view of a conventional nail polish bottle 38 having a cylindrical screw on top 36. The side of the cap may have a smooth surface or a surface that has vertical serrations or ridges 37.

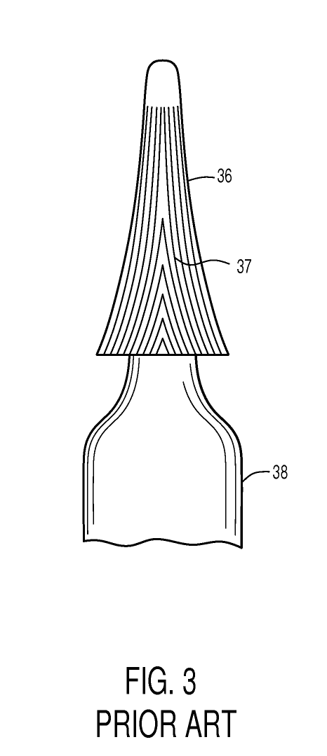

Looking at FIG. 3, there is shown a perspective view of another conventional nail polish bottle 38 having a conical shaped screw on top 36. The side of the cap may have a smooth surface or a surface that has vertical serrations or ridges 37.

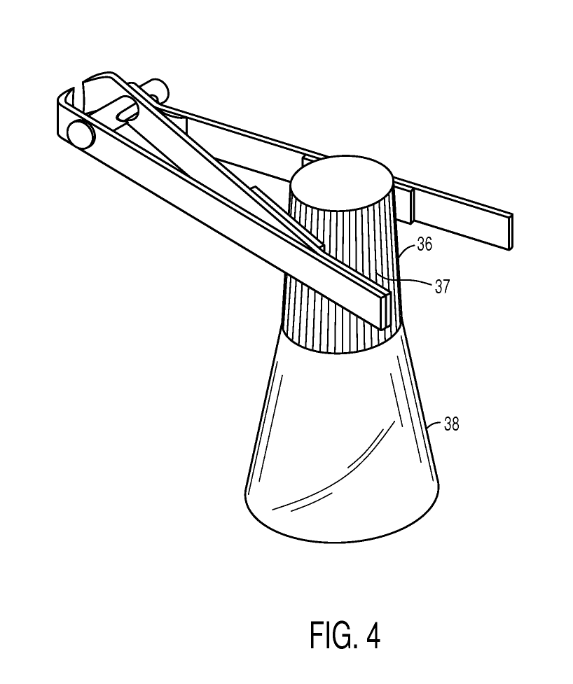

Referring to FIG. 4, there is shown a perspective view of the nail clipper in its operation position in accordance with the principles of the invention positioned to twist the top off a bottle of nail polish.

In accordance with this invention, because gripping material on the handles are of a yieldable material, either cylindrical or conical screw on tops of nail polish bottles can be gripped and twisted off the top of the bottles.

In another embodiment of the invention, the pads can comprise separate layers of yieldable gripping material, or the like, cemented in place.

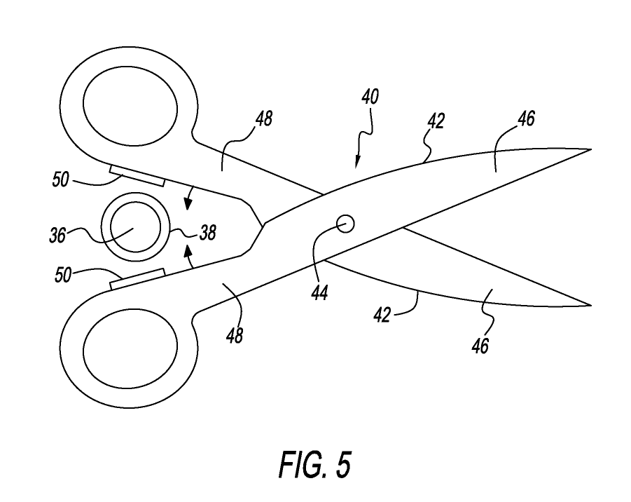

Referring to FIG. 5, there is shown another embodiment of the invention which utilizes a known type of scissors 40. Such known scissors comprise two arms 42 mutually rotatable about a pin 44 joining the two arms. Portions 46 of the arms forward of the pin 44 are cutting blades of the scissors, and arm portions 48 rearward of the pin are the scissor handles. In accordance with the principles of this invention, facing, oppositely disposed surfaces of the handles are provided with elastomeric pads 50 such as, for example, rubber. When the handles are moved apart, a gap; between the two pads is opened into which a cap 36 on a bottle 38, see FIG. 3 or FIG. 4, can be inserted to be clamped by squeezing the handles together. The scissors is then rotated counter clockwise while holding the bottle steady to unscrew the cap from the bottle.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art of utilize the invention in various embodiments and with various modifications as are suited to the particular use contemplated. All such modifications and variation are within the scope of the invention as determined by the appended claims when interpreted in accordance with the breadth to which they are entitled.

What is claimed is:

1. A hand tool including means for performing a cutting function and a nail polish bottle cap twist off function comprising:
a first member in the form of an elongated lever pivotally mounted for movements, by hand of a user, towards and away from a second member having a cutting edge for performing a finger nail of toe nail cutting function; and
yieldable gripping material on surfaces facing toward one another of said first and second members for twist off clamping engagement with the cap of a nail polish bottle disposed between said pads.

2. The hand tool as in claim 1 wherein said yieldable gripping material is a pad of elastomeric material.

3. The hand tool as in claim 1 wherein said yieldable gripping material is a pad of rubber.

4. The hand tool as in claim 3 wherein said pad of rubber has a surface that is smooth.

5. The hand tool as in claim 3 wherein said pad of rubber has a surface that is rough.

6. The hand tool as in claim 3 wherein said pad of rubber has a surface that has serrations.

7. The hand tool as in claim 3 wherein said pad of rubber has a surface that has transverse ridges.

8. The hand tool as in claim 1 wherein said yieldable gripping material is a pad of yieldable plastic.

9. The hand tool as in claim 8 wherein said pad of yieldable plastic has a surface that is smooth.

10. The hand tool as in claim 8 wherein said pad of yieldable plastic has a surface that is rough.

11. The hand tool as in claim 8 wherein said pad of yieldable plastic has a surface that has serrations.

12. The hand tool as in claim 8 wherein said pad of yieldable plastic has a surface that has transverse ridges.

13. The hand tool as in claim 1 wherein said yieldable gripping material is a sleeve or hollow cylinder of elastomeric material.

14. The hand tool as in claim 13 wherein said sleeve or hollow cylinder of elastomeric material is a pad of rubber or yieldable plastic.

15. The hand tool as in claim 13 wherein said sleeve or hollow cylinder of rubber or yieldable plastic has a surface that is smooth.

16. The hand tool as in claim 13 wherein said sleeve or hollow cylinder of rubber or yieldable plastic has a surface that is rough.

17. The hand tool as in claim 13 wherein said sleeve or hollow cylinder of rubber or yieldable plastic has a surface that has serrations.

18. The hand tool as in claim 13 wherein said sleeve or hollow cylinder of rubber or yieldable plastic has a surface that has transverse ridges.

19. The hand tool as in claim 1 wherein said hand tool is a nail clipper including a third member forming with said second member a pair of elongated members joined at first ends of said members and diverging towards second spaced apart member ends having facing cutting edges.

20. A hand tool including means for performing a cutting function and a nail polish bottle cap twist off function comprising:
a first member pivotally coupled to a second member having handles at a first side of the pivot for movements, by hand of a user, towards and away from each other and cutting edges at the second side of the pivot for performing a cutting function; and
yieldable gripping material on surfaces facing toward one another of said first and second members on the first side for twist off clamping engagement with the cap of a nail polish bottle disposed between said pads;
wherein said hand tool is a scissors.
